(19) United States
(12) Patent Application Publication
(10) Pub. No.: US 2022/0300907 A1
(43) Pub. Date: Sep. 22, 2022

(54) SYSTEMS AND METHODS FOR CONDUCTING JOB ANALYSES

(71) Applicant: Wonderlic, Inc., Vernon Hills, IL (US)

(72) Inventors: Ross Daniel Piper, Chicago, IL (US); Abdallah Khaled Mostafa Kamal Aboelela, Brooklyn, NY (US); Guglielmo Menchetti, Chicago, IL (US)

(21) Appl. No.: 17/697,316

(22) Filed: Mar. 17, 2022

Related U.S. Application Data
(60) Provisional application No. 63/163,430, filed on Mar. 19, 2021.

(51) Int. Cl. G06Q 10/10; G06Q 10/06

(52) U.S. Cl. CPC G06Q 10/1053; G06Q 10/06393

(57) ABSTRACT

The present disclosure, in various embodiments, generally relates to systems and methods for conducting job analysis, and more particularly relates to systems and methods for utilizing machine learning and/or artificial intelligence to perform automatic categorization and analysis of jobs for use by employers. Embodiments provide systems and methods for gathering information related to a job (such as job title and associated data from preexisting jobs databases), creating a numerical job vector describing that job, and conducting a job analysis using the numerical job vector.

### CROSS-REFERENCE TO RELATED APPLICATIONS

This application claims the benefit of and priority to U.S. Provisional Application No. 63/163,430, filed Mar. 19, 2021, the contents of which are incorporated herein by reference in their entirety.

### TECHNICAL FIELD

The present disclosure, in various embodiments, generally relates to systems and methods for conducting job analysis, and more particularly relates to systems and methods for utilizing machine learning and/or artificial intelligence to perform automatic categorization and analysis of jobs for use by employers.

### BACKGROUND

Comparing and classifying different jobs so as to determine whether an individual is qualified or otherwise able to perform a job is an arduous task. Historically, this process involved having one or more individuals manually review and classify jobs on their use of one or more quantitative or qualitative measures of the knowledge, skills, abilities, and interests (referred to as “KSAIs”) required for the task along with the level of education or experience required to qualify an individual to perform that task. This manual process must be repeated for each and every new job or role, as new roles generally could not be analogized to those that have previously been analyzed without performing the fulsome review.

While several existing databases of job analyses exist, these databases are of limited utility when considering newly created jobs or roles that are not already included in the database. Similarly, such databases do not account for “custom” or unusual titles or descriptors that an employer may assign to a job or role. Even using an existing database, an employer must still conduct a fulsome analysis of any jobs not contained in the database.

One of the most heavily utilized databases of job information is the U.S. government-maintained Occupational Information Network (O*NET), which is maintained by the U.S. Department of Labor's Employment and Training Administration. The O*NET database contains information on each job detailed therein in the form of a “profile.” These profiles include (but are not limited to) information regarding the associated job, such as the “Job Family,” “Job Zone,” and associated KSAIs for the job. Each profile in the database has a specific primary job title, and may optionally contain one or more alternative titles by which that job is known. As used in the O*NET database: (i) a “Job Family” is a group of occupations based upon work performed, skills, education, training, and credentials; (ii) a “Job Zone” is a group of occupations placed into a category (of which there are currently five in total) based on levels of education, experience, and training necessary to perform the occupation; and (iii) KSAIs are the Knowledge, Skills, Abilities, and Interests required to perform the associated job successfully, with each KSAI assigned a “level” value (currently between 1 and 5).

As used in the KSAIs: (i) “Knowledge” is defined as “organized sets of principles and facts applying in general domains”; (ii) “Skills” are defined as “categorized job related job capacities” and include the categories of “Basic Skills,” “Complex Problem Solving Skills,” “Resource Management Skills,” “Social Skills,” “Systems Skills,” and “Technical Skills”; (iii) “Abilities” are defined as “enduring attributes of the individual that influence performance”; and (iv) “Interests” are defined as “preferences for work environments and outcomes.”

The O*NET database has several limitations, including its inability to keep up with the changing nature and variety of titles of jobs over time. Of particular concern, different companies frequently utilize different titles for similar jobs, making it difficult to classify jobs by title alone when reviewing the O*NET database. While efforts have been undertaken previously to match similar jobs having different titles in the O*NET database, these efforts have been limited and have relied on extensive manual review to attempt to identify such similar jobs. Such approaches are neither scalable nor sustainable, and as noted above, are impacted by the perspectives and biases of the individual(s) performing the classification as no objective standards exist to quantify jobs as being “similar” or related.

Another frequently utilized database of job information is the European Skills, Competences, Qualifications and Occupations (ESCO) database maintained by the European Commission since 2010. The ESCO database classifies jobs according to the International Standard Classification of Occupations (ISCO) classification structure, which divides jobs into ten major groups: (i) managers, (ii) professionals, (iii) technicians and associate professionals, (iv) clerical support workers, (v) service and sales workers, (vi) skilled agricultural, forestry and fishery workers, (vii) craft and related trades workers, (viii) plant and machine operators and assemblers, (ix) elementary occupations, and (x) armed forces occupations. Each of these major groups is then further divided into sub-major, minor, and unit groups. Jobs are classified based on skill level and specialization required to perform the necessary tasks and duties associated with the job.

The ESCO database suffers the same disadvantages as the O*NET database. It both is unable to keep pace with the changing nature and variety of titles of jobs over time and is difficult (if not impossible) to use for classifying jobs by title alone.

In addition to being time-consuming and expensive, existing manual processes for classifying jobs can be subjective and thus prone to bias or error based on the skills and perspectives of the individual(s) performing the analysis.

Thus, a long-felt and unmet need exists for improved methods and systems for creating and providing job analyses, including methods and systems for objectively and systematically conducting job analyses so as to reduce the time, expense, and subjectivity involved in conducting the analyses.

### BRIEF SUMMARY OF THE DISCLOSURE

This summary is provided to introduce a selection of concepts in a simplified form that are further described in the detailed description of the disclosure. This summary is not intended to identify key or essential inventive concepts of the claimed subject matter, nor is it intended to determine the scope of the claimed subject matter.

The presently described systems and methods overcome the disadvantages of the prior art by providing novel systems and methods for objectively analyzing and classifying novel jobs and roles.

An embodiment of the present invention provides a system and method for gathering information related to a job (such as job title), creating a numerical job vector describing that job, and applying machine learning and/or artificial intelligence algorithms to conduct a job analysis.

### BRIEF DESCRIPTION OF THE SEVERAL VIEWS OF THE DRAWING(S)

The foregoing summary, as well as the following detailed description of the disclosure, is better understood when read in conjunction with the appended drawings. For the purpose of illustrating the disclosure, exemplary constructions of the inventions of the disclosure are shown in the drawings. However, the disclosure and the inventions herein are not limited to the specific methods and instrumentalities disclosed herein.

FIG. 1 is an illustration of an exemplary network environment for implementing systems and methods in accordance with the present disclosure.

FIG. 2 is an illustration of an exemplary system architecture in accordance with an embodiment.

FIG. 3 is an illustration of second exemplary system architecture in accordance with an embodiment.

FIG. 4 is an illustration of an third exemplary system architecture in accordance with an embodiment.

FIG. 5 is a process flow diagram illustrating the flow and transformation of information using a method in accordance with an embodiment.

FIG. 6 is an illustration of an exemplary user interface for displaying the results of a job analysis in accordance with an embodiment.

FIG. 7 is an illustration of exemplary data structures in accordance with an embodiment.

FIG. 8 is a graphical illustration of an exemplary vector space in accordance with an embodiment.

FIG. 9 is a flow chart illustrating the flow of information through a system architecture in accordance with a first embodiment.

FIG. 10 is a flow chart illustrating the flow of information through a system architecture in accordance with a second embodiment.

FIG. 11 is a flow chart illustrating the flow of information through a system architecture in accordance with a third embodiment.

FIG. 12 is a flow chart of illustrating a method for training a machine learning algorithm to perform a job analysis in accordance with an embodiment.

### DETAILED DESCRIPTION OF THE DISCLOSURE

The present disclosure is not limited to the particular details of the systems and methods depicted and described herein, and other modifications and applications may be contemplated. Further changes may be made in the systems or methods without departing from the true spirit and scope of the disclosure herein involved. It is intended, therefore, that the subject matter in this disclosure should be interpreted as illustrative, not in a limiting sense.

For purposes of contrasting various embodiments with the prior art, certain aspects and advantages of these embodiments are described where appropriate herein. Of course, it is to be understood that not necessarily all such aspects or advantages may be achieved in accordance with any particular embodiment. Modifications and variations can be made by one skilled in the art without departing from the sprit and scope of the invention. Moreover, any one or more features of any embodiment may be combined with any one or more other features of any other embodiment, without departing from the scope of the invention.

Disclosed herein are systems and methods that seamlessly integrate multiple data sources in order to objectively analyze and classify a novel job or role in relation to one or more “known” jobs or roles that have been previously analyzed and classified. In embodiments, a single uniform interface may be presented to users on various platforms. In alternative embodiments, the user interface may be customized to the specific platform in use (such as to take advantage of specific features of that platform). By enabling users to objectively categorize and classify jobs having custom titles, a user is able to quickly gain insight into KSAIs and other attributes of a job, enabling valuable insights without requiring manual or subjective processes that could otherwise be time- and labor-intensive and result in significant errors or biases. By using predetermined models and machine learning, a user does not need to be proficient in programming or categorization.

The following disclosure as a whole may be best understood by reference to the provided detailed description when read in conjunction with the accompanying drawings, drawing description, abstract, background, field of the disclosure, and associated headings. Identical reference numerals when found on different figures identify the same elements or a functionally equivalent element. The elements listed in the abstract are not referenced but nevertheless refer by association to the elements of the detailed description and associated disclosure.

Network Architecture

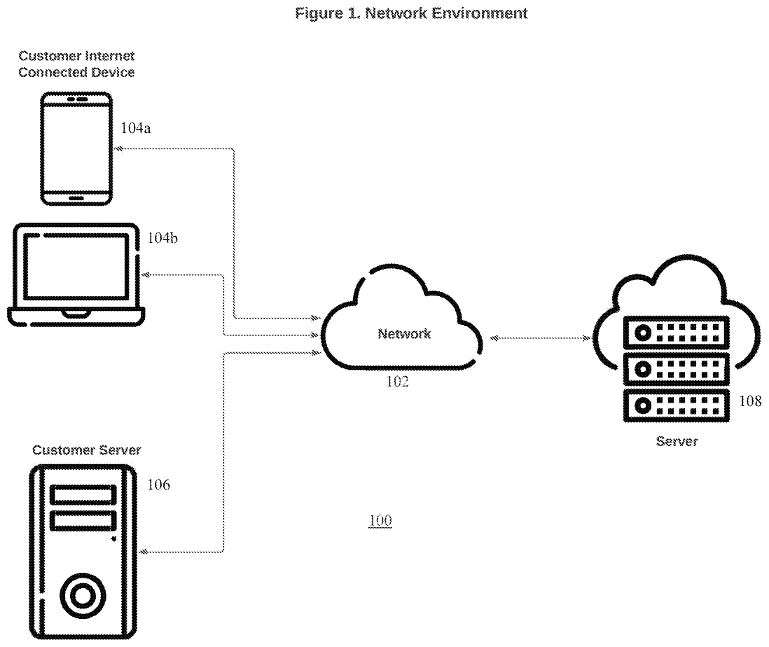

As shown in FIG. 1, in an embodiment, a system 100 in accordance with the present disclosure is implemented using a computing device (or server) 108. In an embodiment, the server 108 is configured to implement the various modules and carry out the various methods described herein. In alternative embodiments, the computing device 108 may comprise one or more distinct computing devices configured to implement a software-based platform as described in greater detail below.

The computing device 108 is connected to one or more client devices 104 and/or one or more client servers 106 via one or more networks 102 such as a local area network (LAN), a wide area network (WAN) such as the Internet, telephone networks including telephone networks with dedicated communication links and/or wireless links, and wireless networks. In the illustrative example shown in FIG. 1, the network 102 comprises the Internet. As such, the computing device 108 and the client devices 104 and/or client server 106 may be geographically separated. In an embodiment, the network 102 comprises a plurality of separate networks (e.g., a plurality of separate LANs) that are linked together (e.g., by the Internet) such that the various elements of the network 102 are geographically separated from one another. Various hardware devices (including but not limited to routers, modems, switches, etc.) may separate the elements of the system 100, so long as the various elements are communicatively coupled together as shown in FIG. 1.

In an embodiment, the computing device 108 illustrated in FIG. 1 comprises one or more storage devices configured to contain computer-readable instructions, one or more central processing units (CPUs) communicatively coupled to the one or more storage devices and configured to execute the computer-readable instructions, an input/output (I/O) unit communicatively coupled to the one or more CPUs and configured to relay data to other devices, and a memory communicatively coupled to the one or more CPUs. The computing device 108 may further comprise a display device and/or one or more standard input devices such as a keyboard, a mouse, speech processing means, or a touchscreen. In an embodiment, the computing device 108 is a server, or a cluster of servers, and lacks a display or local input devices (instead gathering all inputs via network 102 or one or more other connections to other elements, such as database 110).

The one or more client devices 104 may comprise commercially available computing devices, such as desktop computers, laptop computers, smartphones, etc. In an embodiment, each of the client devices 104 comprises a display device and an input device as described herein and is configured to render a graphical user interface (“GUI”) that is used to convey information to and receive information from a user. The GUI includes any interface capable of being displayed on a display device including, but not limited to, a web page, a display panel in an executable program running locally on the client device 104, or any other interface capable of being displayed to the user. The GUI may be transmitted to the client device 104 from the computing device 108. In the illustrative embodiment shown in FIG. 1, in accordance with the present invention, the GUI is displayed by the client device 104 using a browser or other viewing software such as, but not limited to, Microsoft Edge, Google Chrome, Apple Safari, or Mozilla Firefox, or any other commercially available viewing software. In an embodiment, the GUI is generated using a combination of commercially available hypertext markup language (“HTML”), cascading style sheets (“CSS”), JavaScript, and other similar standards. In alternative embodiments, the client devices 104 each comprise one or more CPUs coupled to memory and/or storage devices and are configured to generate the GUI using instructions stored thereon.

In an embodiment, the computing device 108 is connected to one or more client servers 106. The client server 106 comprises one or more CPUs and storage devices, but may be configured to operate without a display and interact with computing device 108 without the use of a GUI.

System Architecture and Process Flow

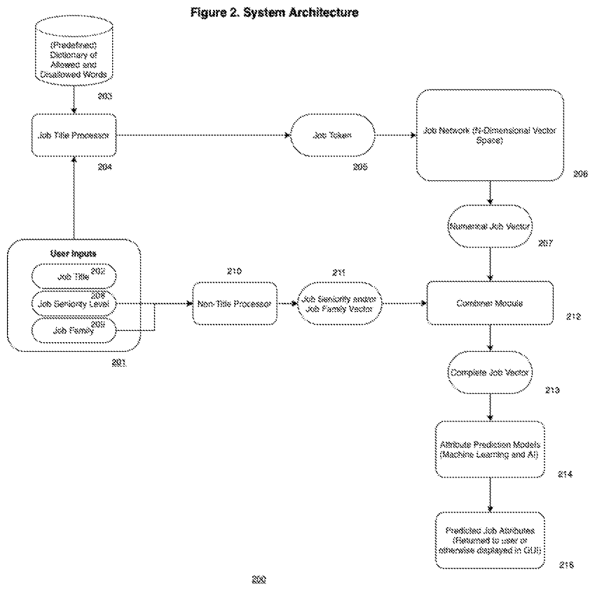

FIG. 2 depicts an exemplary system architecture diagram of the platform 200 configured to operate on the computing device 108, illustrating the flow and transformation of information within the computing device 108 in accordance with an embodiment. As shown, the platform 200 receives a set of user inputs 201, with each such set of user inputs 201 comprising a job title 202. A set of user inputs 201 may further comprise a job seniority level 208 and/or a job family 209.

The set of user inputs 201 is provided by a user of one of the client devices 104 and/or client server 106. In an embodiment, a user manually types in the user input 201 into a text field in a GUI. In an alternative embodiment, a client server 106 is configured to transmit one or more sets of user inputs 201 to the computer device 108. Each set of user inputs 201 is analyzed separately. As will be clear to one of skill in the art, multiple sets of user inputs 201 may be provided simultaneously (and then either processed in parallel or sequentially) or in a discrete sequence, allowing a single computing device 108 to process multiple sets of user inputs 201 provided by a single user on a single client device 104 or client server 106 or from multiple discrete users of multiple client devices and/or client servers 106.

The job title 202 may be a custom job title (and does not need to be selected from a preexisting database). As discussed above, the user may also provide a job seniority level 208 and/or a job family 209 if known. The job seniority level 208 can also be a custom level specified by the user or a standard job seniority level (such as is specified in the O*NET database, the ESCO database, or another suitable public or proprietary database of jobs information). The job family 209 is limited to predetermined categories (such as those specified in the O*NET database, ESCO database, or a similar database).

The job title 202 is processed by a job title processor 204 to generate a job token 205. In the embodiment shown, the job processor 204 is connected to a database 203 comprising a predefined dictionary of allowed and/or disallowed words. The job title processor 204 creates the job token by (i) removing punctuation and stopwords from the job title 202; (ii) expanding abbreviation into full component words; (iii) lemmatizing each word in the job title 202; and (iv) distilling the revised job title down by removing words such as business names and proper nouns (which would otherwise improperly distinguish similar or identical jobs) that do not appear in a predefined “allowed” dictionary or which do appear in a predefined “disallowed” dictionary in the database 203 and the component words are then ordered alphabetically and connected using underscores. In this manner, job tokens 205 may be directly compared (and duplication of job tokens 205 is minimized). As an example, the unique job titles “Alpha, Inc. Senior Manager of Customer Success” and “Beta LLC Customer Success Manager” would both be tokenized as “customer_manager_success.” In an embodiment, words relating to seniority (as determined using a predetermined dictionary in the database 203) may be used to fill in job seniority level 208 (if that information is omitted) or to validate the job seniority level 208 (if that information is provided).

In the embodiment shown, the job token 205 is then converted into a numerical job vector 207 using natural language processing. In an embodiment, one or more neural network models (referred to collectively as the job network 206) is trained on a known dataset to learn word associations; the one or more models is then provided with the job token 205 and generates an N-dimensional vector (referred to as numerical job vector 207). In an embodiment, a word embedding algorithm, (such as, but not limited to, Word2Vec, GloVe, ELMO, and BERT) is used to create the numerical job vector 207 based on the job token 205. Multiple numerical job vectors 207 may be compared to determine the level of relatedness or similarity between the corresponding job titles 202. This process is re-creatable and consistent, as a given job title 202 will produce the same job token 205 and the same numerical job vector 207 until and unless the one or more models comprising the job network 206 are changed or revised (such as could occur, for example, as the models are trained and refined using the processes discussed below).

If provided, the job seniority level 208 and/or job family 209 are converted into vector representations 211 through the non-title processor 210. These numerical representations 211 are then incorporated into the complete job vector 213 using the combiner module 212, which may incorporate the numerical job vector 207, the job seniority level, and/or the job family vectors 211.

The system then analyzes the complete job vector 213 using one or more attribute prediction models 214, which may be created using machine learning and/or artificial intelligence algorithms. As discussed below, these models can also be continually retrained in order to refine the models 214 and further increase their accuracy. The attribute prediction models 214 create a set of predicted job attributes 215 that may then be provided to the user.

As will be clear to one of skill in the art, this same process may be used to analyze job information provided by one or more job databases (whereby instead of having the requisite information provided by a user, it is pulled directly from the corresponding database), such as a database stored on a client server 106. This can be done both to supplement the job profiles available to the system and to train (or improve) the attribute prediction models 214 using jobs that have already been analyzed and classified using a separate system or method. In an embodiment, the attribute prediction models 214 may be created by analyzing an existing corpus of information, such as a database of resumes and the O*NET job profile database, the ESCO database, or another suitable public or proprietary database of jobs data. By processing such corpuses, two data sets are created: (i) job tokens that correspond to profiles obtained from O*NET, ESCO, or another suitable database and (ii) job tokens for which no corresponding profiles exist in the database. The attribute prediction models 214 may be trained on the first dataset using the numerical representation provided by combining the numerical job vector 207, job zones, and job families' vector representations 211 (also referred to as complete vector 213) as independent variables and the KSAIs and/or other job attributes as dependent variables using machine learning regression and/or classification modeling, such as (but not limited to) Nearest Neighbors, Linear/Logistic regression, Tree-Based Algorithms (Decision Trees, XGBoost, Random Forests, and others), and Neural Networks. Once trained, the attribute prediction models 214 are able to provide predicted job attributes 215 for any complete job vector 213.

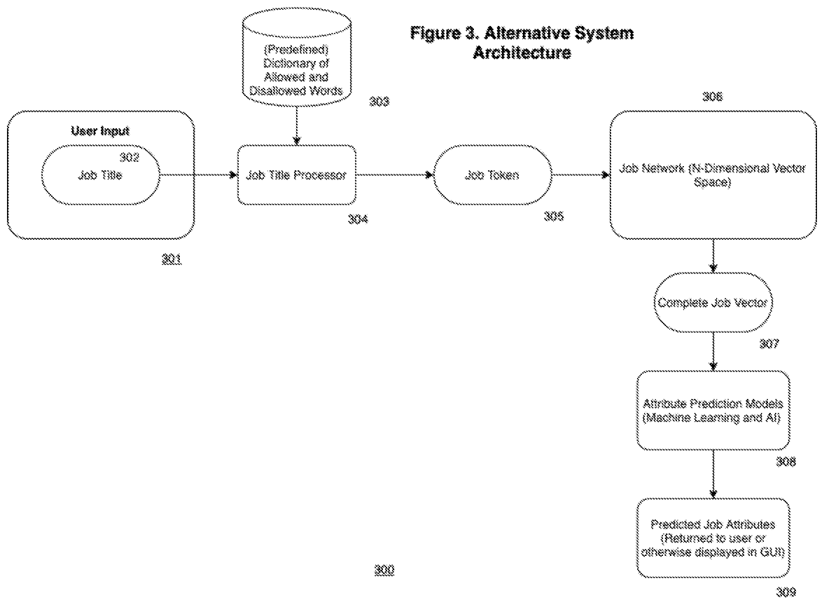

In the embodiment shown in FIG. 3, the user input 301 is limited to the job title 302. The job title is processed through the job title processor 304, applying the same processing steps specified in the previous embodiments, producing a job token 305. The job token is then fed as input to the job network 306 to create a vector representation of the job token 307. The representation is then used by the attribute prediction models 308 which produces the job attributes predictions 309 returned to the user (e.g., by displaying them in a GUI).

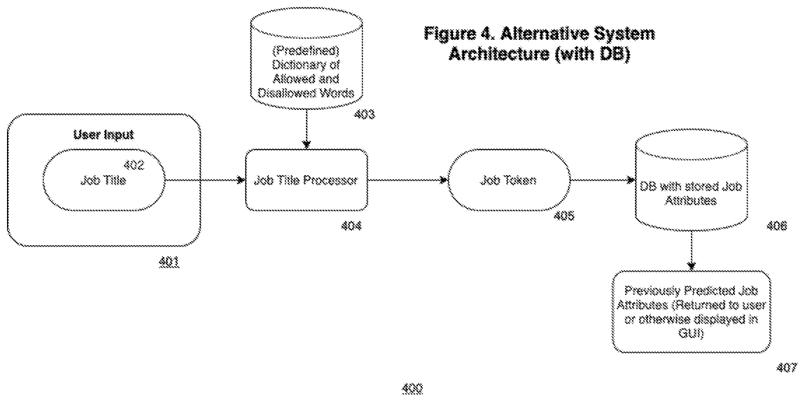

In the embodiment shown in FIG. 4, the system comprises a database 406 of previously determined job attributes each associated with job tokens 405. Such an approach requires storing a database of job attributes 406, which is populated off-line. In this embodiment, the job token 405 is used to query the database 406, which returns predicted job attributes 407 (a subset of the job attributes stored in the database 406) to the user (e.g., for display in a GUI).

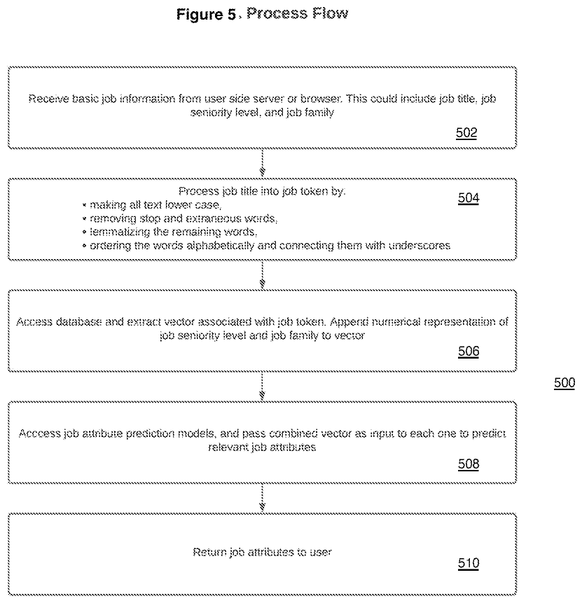

FIG. 5 is a flow chart illustrating the steps of a method 500 for performing a job analysis in accordance with an embodiment. As shown, the method 500 begins by receiving basic job information from a user via a client device 104. As discussed above, the job information includes a job title 202 and, optionally, a job seniority level 208 and/or a job family 209. Next, the job title 202 is processed into a job token at step 504. At step 506, a numerical job vector 207 is created for the job token 205. As discussed above, if the system comprises a database 406 of previously determined job attributes 407, each associated with a job token 405, the job attributes 407 may be retrieved from the database and returned to the user. Otherwise, a new complete job vector 213 is created based on the job title's numerical vector 207, with numerical representations of the job seniority level 208 and/or job family 209 (if available) incorporated as well. At step 508, the complete job vector is processed using the job attribute prediction models 214 in order to generate predicted attributes for the job. At step 510, the method 500 concludes and the predicted job attributes 215 are returned to the user at the client device 104.

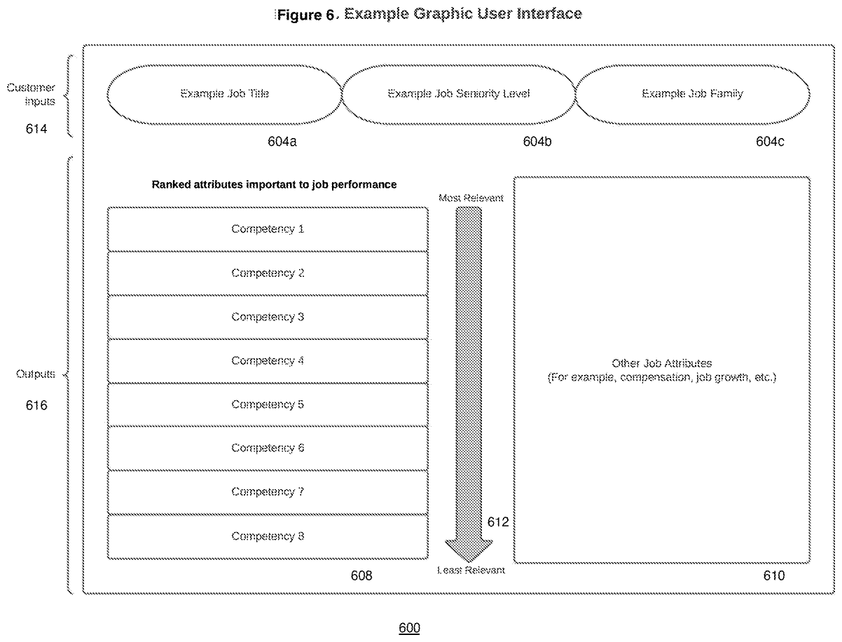

FIG. 6 depicts an exemplary GUI 600 displayed at the client devices 104 after predicted job attributes 215 are generated. The user provides inputs 614 including job title 202 (which is displayed as element 604a), job seniority level 208 (displayed as element 604b), and job family 209 (displayed as element 604c). If any of these elements are not provided, the corresponding area 604 may be blank. Otherwise, these elements 604 reiterate the information previously provided by the user. In an embodiment, the job seniority level 208 and/or job family 209 may be provided as part of the predicted job attributes 215 (in which case the information displayed in elements 604b and 604c would be the predicted values rather than the information provided by the user).

Element 606 provides explanatory text regarding the predicted job attributes 215, of which one or more are presented in ranked order as element 608. In the embodiment shown, a graphical representation of the ranking used is provided as element 612; here, the predicted job attributes 215 are ranked in descending order based on relevancy. Element 610 provides details of other non-job performance-related predicted job attributes 215 (e.g., those related to compensation). Collectively, elements 606-610 display outputs 616 generated by the platform.

Data Structures

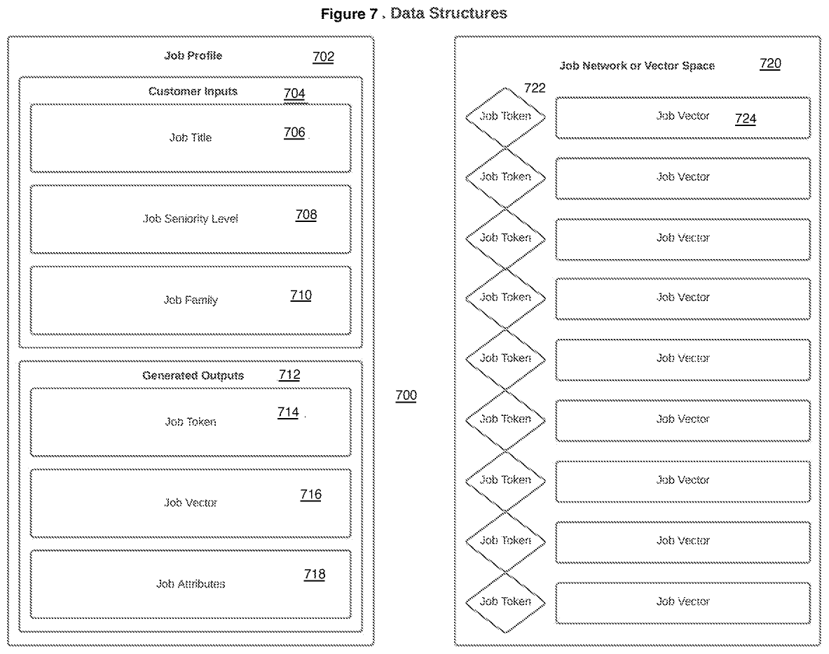

FIG. 7 depicts exemplary data structures 700 comprising a job profile 702 and a job network or vector space 720.

As shown, the job profile 702 may comprise one or more customer inputs in the form of job title 706, job seniority level 708, and job family 710 alongside outputs 712 generated by the platform include job token 714, job vector 716, and job attributes 718. Job profiles 702 may be stored in database 406 and used to provide information to users when a provided job title 202 matches the job title 706 of an existing job profile 702 (or when a computed job token matches that of an existing job token 714).

The job network 720 (also referred to as a vector space) may be stored in a database and correlates a plurality of job tokens 722 to a plurality of job vectors 724. The job network 720 may be further linked to job profiles 702 corresponding to each job token 722, but may include job tokens 722 for which no job profile 702 exists.

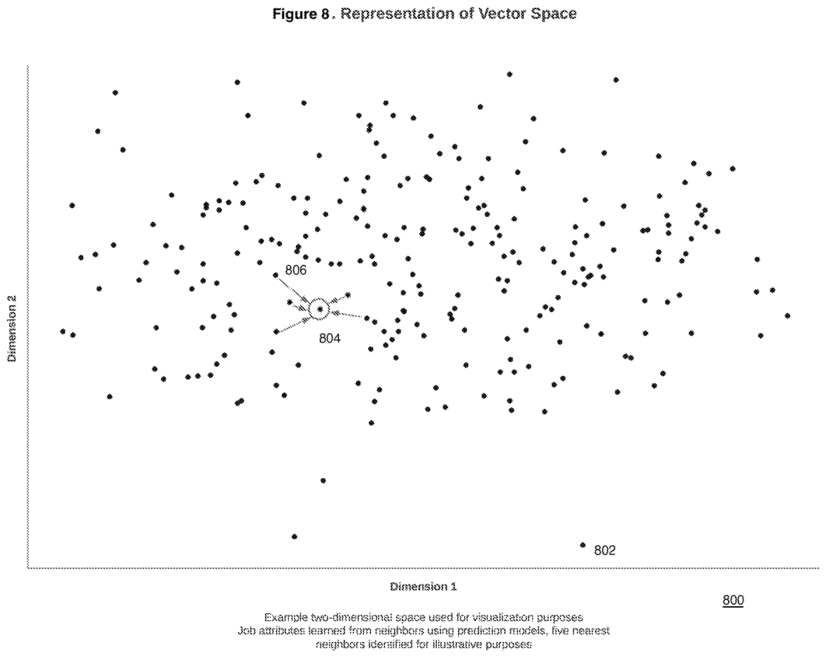

FIG. 8 depicts an exemplary visualization 800 of a plurality of job vectors 802 in two dimensions. As shown, each job vector 802 appears at a unique point on the visualization 800. As will be clear to one of skill in the art, in practice, the plurality of job vectors will be mapped on an N-dimensional space, with the number of dimensions corresponding to the number of attributes encoded in the job vector. As shown, if using a Nearest Neighbors algorithm, a plurality of “nearest neighbors” 806 are determined for a job vector of interest 804. These nearest neighbors 806 are used to generate predicted job attributes using the attribute prediction models. In an embodiment, each job vector may comprise hundreds of discrete dimensions.

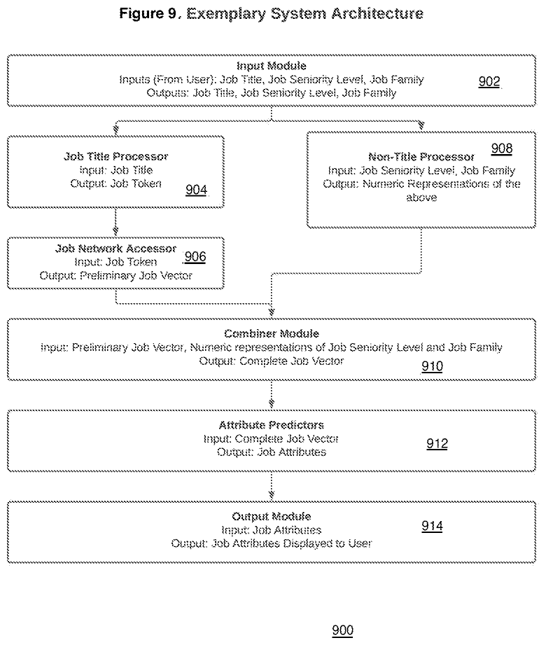

FIG. 9 illustrates the modules comprising an exemplary embodiment of a software-based platform 900 in accordance with the present disclosure. As shown, an input module 902 obtains inputs from a user (i.e., user inputs 201) comprising a job title 202, a job seniority level 208, and/or a job family 209. The job title processor 904 receives the job title 202 and processes it to create a job token 205, as discussed above. The job token 205 is then passed to a job network accessor 906 which creates a preliminary job vector 905 based solely on the job token 205.

Separately, a non-title processor 908 receives the job seniority level 208 and/or job family 209 (if such are provided as part of user input 201) and creates a numeric representation for each. In an embodiment, the numeric representation of the job seniority level 208 uses higher numbers for more senior positions while the numeric representation of job family utilizes a predetermined mapping (such that a given job family always corresponds to the same numeric representation). As will be clear to one of skill in the art, in alternative embodiments, other schemes may be used to create numeric representations of job seniority 208 and job family 209.

A combiner module 910 receives the numerical job vector 207 and numeric representations of job seniority level and job family 211 (if available) and combines them into a complete job vector 213. In instances in which neither job seniority level 208 nor job family 209 are provided, the complete job vector 213 is identical to the numerical job vector 207. Otherwise, where either (or both) a job seniority level 208 or a job family 209 are provided, the complete job vector 213 will differ from the numerical job vector 207 through the incorporation of the numeric representations of those items.

The complete job vector 213 is then provided to the attribute prediction module 912 whereby it is run through one or more attribute prediction models 214 in order to generate one or more predicted job attributes 215. The predicted job attributes 215 are then formatted and provided to a user by the output module 914. Where the user is operating a user device 104 having a display, the output module 914 may format the predicted job attributes 215 for visualization using the GUI. Alternatively, as will be clear to one of skill in the art, the output module 914 may provide formatting instructions to the client device 104 to enable the client device 104 to render the GUI containing the predicted job attributes 215. In further embodiments, the output module 914 may format the predicted job attributes 215 for inclusion in a database and/or use in further analysis, such as by client server 106.

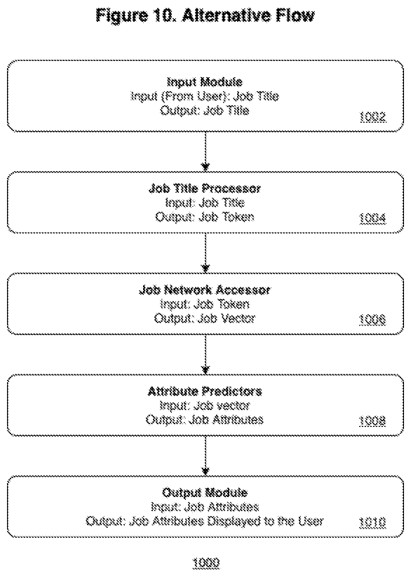

FIG. 10 depicts the modules comprising a second embodiment of a software-based platform 1000 in accordance with the present disclosure. As shown, an input module 1002 obtains the job title 302 as an input from the user. The job title processor 1004 receives the job title 302 provided by the user and processes it to create a job token 305, as discussed above. The job token 305 is then passed to a job network accessor 1006 which creates a numerical job vector 307 (also referred to as a “complete” job vector) based solely on the job token 305.

Similarly to the embodiment depicted in FIG. 9, the numerical job vector 307 is then given as an input to the attribute prediction module 1008 to generate one or more predicted job attributes 309. The predicted job attributes 309 may then be formatted as previously described, and provided to a user by the output module 1010.

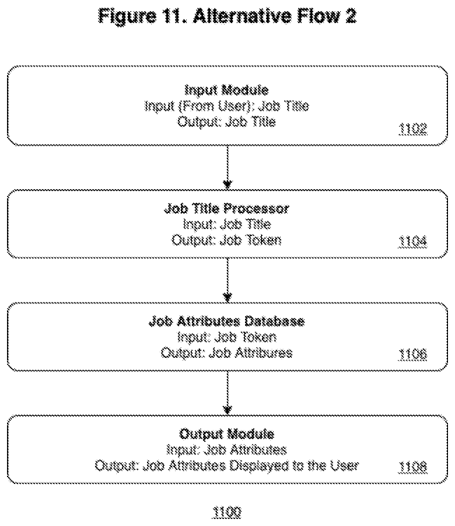

FIG. 11 depicts the modules comprising a third embodiment of a software-based platform 1100 in accordance with the present disclosure. In the embodiment shown, the job attributes associated with a job token 405 are stored in a database 406. In the embodiment shown, the job title 402 is processed by the job title processor 1104, which produces a job token 405. The job token 405 is used to query the database 406 to retrieve the previously stored job attributes associated with the job token 406. The predicted job attributes 407 may then be formatted as previously described, and provided to a user by the output module 1106.

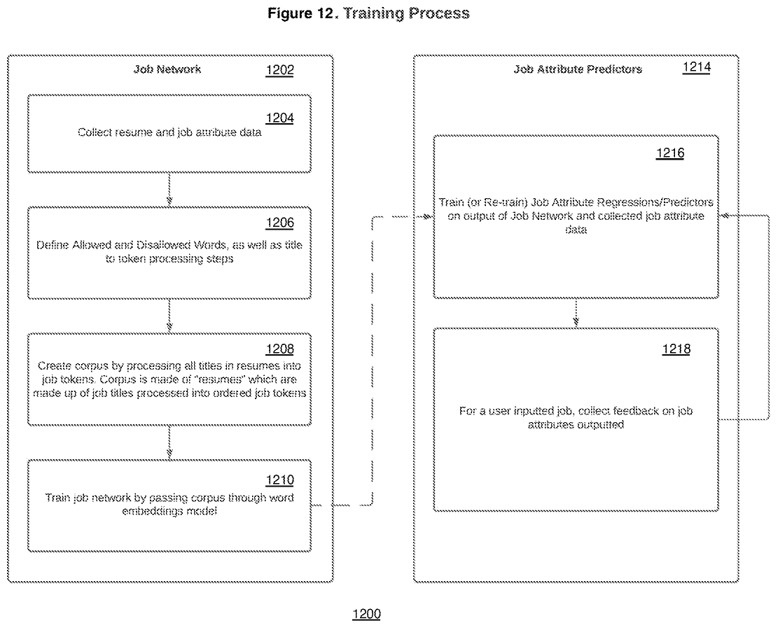

FIG. 12 depicts an exemplary process flow diagram of a method 1200 of training attribute prediction modules. As shown, the method operates using two separate modules: a job network 1202 and job attribute predictors 1214.

With the job network 1202, the method begins at step 1204 with the collection of resume and job attribute data. This information may be obtained from a preexisting public or proprietary database. In embodiments, information may be obtained from the O*NET database, the ESCO database, or a similar preexisting jobs database. In alternative embodiments, a custom database may be created by collecting information, such as by scraping publicly available websites containing jobs information, inputting resumes obtained from a company, or conducting surveys of companies and/or employees. Other suitable mechanisms for obtaining and formatting the needed jobs data will be clear to one of skill in the art.

Next, at step 1206, allowed and/or disallowed words for job titles are determined and stored to create a predetermined dictionary. As discussed above, this dictionary may be used in tokenizing job titles so as to prevent undesired words from being included in a job token and/or ensure only approved words are used in the job token.

At step 1208, a corpus is created by processing job titles in the database collected at step 1204; the corpus comprises ordered job tokens taken from the job titles extracted from the database.

At step 1210, the job network 1202 is trained by passing the corpus through one or more word embeddings models using machine learning. Once trained, the word embeddings model is used by the job title processor 904 to create job tokens based on job titles, as discussed above.

The method 1200 proceeds to the job attributes predictors 1214, where at step 1216 the job attribute predictors receive the output of the job network 1202 (i.e., word vectors) and use it to train (or re-train) the job attributor predictor modules using the job attribute data collected at step 1204. In an embodiment, if a user provided user input 201 used to create the job vector, the method continues at step 1218 where user feedback is solicited and collected regarding the accuracy of the predicted job attributes. That feedback is then used to retrain the job attribute models at step 1216. To that end, in an embodiment, steps 1216 and 1218 may be rerepeated recursively to improve the job attribute models. In an embodiment, this feedback takes the form of re-rankings of predicted attributes (with the re-rankings fed back into the prediction module at step 1216).

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

Any other undisclosed or incidental details of the construction or composition of the various elements of the disclosed embodiment of the present invention are not believed to be critical to the achievement of the advantages of the present invention, so long as the elements possess the attributes needed for them to perform as disclosed. Illustrative embodiments of the present invention have been described in considerable detail for the purpose of disclosing a practical, operative structure whereby the invention may be practiced advantageously. The designs described herein are intended to be exemplary only. The novel characteristics of the invention may be incorporated in other structural forms without departing from the spirit and scope of the invention. The invention encompasses embodiments both comprising and consisting of the elements described with reference to the illustrative embodiments. Unless otherwise indicated, all ordinary words and terms used herein shall take their customary meaning and all technical terms shall take on their customary meaning as established by the appropriate technical discipline utilized by those normally skilled in that particular art area.

1. A method of performing job analyses, the method comprising:
obtaining inputs from a user, the inputs comprising a job title;
creating a job token based on the inputs;
generating a numerical job vector based on the job token;
generating a complete job vector based on the numerical job vector;
utilizing a machine learning model to determine predicted job attributes based on the complete job vector and a database comprising one or more predetermined job vectors;
providing the predicted job attributes to the user;
wherein the machine learning model has been trained to learn implicit patterns in a training data set.

2. The method of claim 1, wherein the job title comprises a plurality of characters comprising one or more words and one or more abbreviations and the step of creating the job token based on the inputs comprises:
evaluating each of the plurality of characters comprises a letter character, a punctuation character, or a number character;
removing the punctuation characters from the job title;
replacing each number character with a corresponding word;
replacing the one or more abbreviations in the job title with corresponding full component words;
lemmatizing each of the one or more words in the job title to create a lemmatized word list; and
consulting a predefined word dictionary and removing one or more disallowed words from the lemmatized word list.

3. The method of claim 1, wherein the job title contains one or more component words and the step of creating the job token based on the inputs comprises ordering the one or more component words alphabetically and connecting the one or more component words in alphabetical order.

4. The method of claim 1, wherein the step of generating the numerical job vector based on the job token comprises using a word embedding algorithm to generate the numerical job vector.

5. The method of claim 1, wherein the inputs further comprise one or more job attributes each comprising one or more of a job seniority level and a job family, the method further comprising:
creating one or more numerical representations, each created using a respective one of the one or more the job attributes; and
combining the numerical job vector and the one or more numerical representation to create a complete job vector.

6. The method of claim 1, wherein the machine learning model has been trained by:
obtaining training inputs from a training data set, the training inputs comprising a training job title;
obtaining job attributes from the training data set, the job attributes comprising one or more KSAIs;
creating a job token based on the inputs;
generating a numerical job vector based on the job token;
utilizing a machine learning model to determine predicted job attributes based on the numerical job vector and a database comprising one or more predetermined complete job vectors; and
providing the predicted job attributes to the user;
wherein the machine learning model has been trained to learn implicit patterns in a training data set.

7. The method of claim 6, wherein the training inputs further comprise one or more job zones and one or more job families.

8. A system for performing job analyses, the system configured to:
obtain inputs from a user, the inputs comprising a job title;
create a job token based on the inputs;
generate a numerical job vector based on the job token;
generate a complete job vector based on the numerical job vector;
utilize a machine learning model to determine predicted job attributes based on the numerical job vector and a database comprising one or more predetermined job vectors; and
provide the predicted job attributes to the user;
wherein the machine learning model has been trained to learn implicit patterns in a training data set.

9. The system of claim 8, wherein the job title comprises a plurality of characters comprising one or more words and one or more abbreviations and the step of creating the job token based on the inputs comprises:
evaluating each of the plurality of characters comprises a letter character, a punctuation character, or a number character;
removing the punctuation characters from the job title;
replacing each number character with a corresponding word;
replacing the one or more abbreviations in the job title with corresponding full component words;
lemmatizing each of the one or more words in the job title to create a lemmatized word list; and
consulting a predefined word dictionary and removing one or more disallowed words from the lemmatized word list.

10. The system of claim 8, wherein the job title contains one or more component words and the step of creating the job token based on the inputs comprises ordering the one or more component words alphabetically and connecting the one or more component words in alphabetical order.

11. The system of claim 8, wherein the numerical job vector is generated using a word embedding algorithm.

12. The system of claim 8, wherein the inputs further comprise one or more job attributes each comprising one or more of a job seniority level and a job family, the system further configured to:
create one or more numerical representations, each created using a respective one of the one or more the job attributes; and
combine the numerical job vector and the one or more numerical representation to create a complete job vector.

13. The system of claim 8, wherein the machine learning model has been trained by:
obtaining training inputs from a training data set, the training inputs comprising a training job title;
obtaining job attributes from the training data set, the job attributes comprising one or more KSAIs;
creating a job token based on the inputs;
generating a numerical job vector based on the job token;
utilizing a machine learning model to determine predicted job attributes based on the numerical job vector and a database comprising one or more predetermined complete job vectors;
providing the predicted job attributes to the user;
wherein the machine learning model has been trained to learn implicit patterns in a training data set.

14. The system of claim 13, wherein the training inputs further comprise one or more job zones and one or more job families.

15. A non-transitory computer readable storage medium including executable instructions, wherein the instructions, when executed by circuitry, cause the circuitry to perform a method comprising steps of:
obtaining inputs from a user, the inputs comprising a job title;
creating a job token based on the inputs;
generating a job vector based on the job token;
utilizing a machine learning model to determine predicted job attributes based on the job vector and a database comprising one or more predetermined job vectors;
providing the predicted job attributes to the user;
wherein the machine learning model has been trained to learn implicit patterns in a training data set.

16. The non-transitory computer readable storage medium of claim 15, wherein the job title comprises a plurality of characters comprising one or more words and one or more abbreviations and the step of creating the job token based on the inputs comprises:
evaluating each of the plurality of characters comprises a letter character, a punctuation character, or a number character;
removing the punctuation characters from the job title;
replacing each number character with a corresponding word;
replacing the one or more abbreviations in the job title with corresponding full component words;
lemmatizing each of the one or more words in the job title to create a lemmatized word list; and
consulting a predefined word dictionary and removing one or more disallowed words from the lemmatized word list.

17. The non-transitory computer readable storage medium of claim 15, wherein the job title contains one or more component words and the step of creating the job token based on the inputs comprises ordering the one or more component words alphabetically and connecting the one or more component words in alphabetical order.

18. The non-transitory computer readable storage medium of claim 15, wherein the step of generating the numerical job vector based on the job token comprises using a word embedding algorithm to generate the numerical job vector.

19. The non-transitory computer readable storage medium of claim 15, wherein the inputs further comprise one or more job attributes each comprising one or more of a job seniority level and a job family, the steps further comprising:
creating one or more numerical representations, each created using a respective one of the one or more the job attributes; and
combining the numerical job vector and the one or more numerical representation to create a complete job vector.

20. The non-transitory computer readable storage medium of claim 15, wherein the machine learning model has been trained by:
obtaining training inputs from a training data set, the training inputs comprising a training job title;
obtaining job attributes from the training data set, the job attributes comprising one or more KSAIs;
creating a job token based on the inputs;
generating a numerical job vector based on the job token;
utilizing a machine learning model to determine predicted job attributes based on the numerical job vector and a database comprising one or more predetermined complete job vectors; and
providing the predicted job attributes to the user;
wherein the machine learning model has been trained to learn implicit patterns in a training data set.
